(19) United States
(12) Patent Application Publication
(10) Pub. No.: US 2020/0302389 A1
(43) Pub. Date: Sep. 24, 2020

(54) SYSTEM AND METHOD FOR SECURE PARCEL DELIVERY

(71) Applicants: Dathan Wong, Sammamish, WA (US); Ramakrishna Pamarthi, Bellevue, WA (US)

(72) Inventors: Dathan Wong, Sammamish, WA (US); Ramakrishna Pamarthi, Bellevue, WA (US)

(21) Appl. No.: 16/826,426

(22) Filed: Mar. 23, 2020

Related U.S. Application Data
(60) Provisional application No. 62/822,763, filed on Mar. 22, 2019.

(51) Int. Cl. G06Q 10/08; G07C 9/00

(52) U.S. Cl. CPC G06Q 10/0836; G07C 9/00571

(57) ABSTRACT

A system and method for a secure parcel securing device and accompanying application that notifies a parcel recipient when a parcel is delivered, when the device is locked and unlocked, and when the device is moved. The device locks the parcel in a secure container so that it cannot be stolen and if the device is tampered with an alarm sounds, bringing attention directly to the location of the stolen parcel or the device may be located and retrieved by GPS. The device also allows the parcel deliverer to scan the parcel with the barcode scanner and drop the parcel in the container whereby a motor opens and closes the container by extending and retracting a rope built into the top of the container to seal and unseal the container.

### CROSS REFERENCE TO RELATED APPLICATIONS

This application is a Non-Provisional application which claims priority to U.S. Provisional Application No. 62/822,763 filed on Mar. 22, 2019, which is incorporated by reference in its entirety.

### FIELD OF DISCLOSURE

The present invention relates generally to parcel delivery. More particularly, the subject matter relates to a system and method that allows parcels to be delivered by parcel deliverers and then safely secured at an unattended location while notifying the owner of the parcel that the parcel has been delivered and secured where the owner can retrieve the parcel at the unattended location.

### BACKGROUND

Customarily, parcel recipients and consumers would travel and shop at retail stores. Now, more than ever, they are purchasing goods from online market places instead of opting to travel to the conventional brick and mortar store, with online sales making up 9 percent of all retail sales in the United States, as of 2018. Even documentaries have been created to show that people no longer even have to leave their home to receive all the necessities and comforts in every day life. Retail stores, not wanting to fall behind, have also begun to focus on selling products on the Internet. This means that parcel recipients are receiving parcels at their home almost every day during all hours of the day, but the shipment of parcels for delivery to a home or office has been a cumbersome and time-consuming process for both the commercial carrier delivering the parcels and for the parcel recipients. Typically, products must be delivered to a parcel recipient by a commercial carrier. Commercial carriers generally request that the intended recipient be present at the time of delivery. Parcel recipients who live at an upscale apartment complex or have security have personnel or employees to receive and sign for a parcel and then hand off the parcel when the owner arrives, but the typical person does not have access to such amenities.

For homeowners, commercial carriers generally request that the intended recipient be present at the time of delivery. In the absence of the recipient, it is necessary for the commercial carrier to return the parcel to the delivery hub and await personal pickup by the recipient. This is a time-consuming process that may be averted by agreement between the recipient and the commercial carrier that personal receipt of a delivered parcel is not required. In these cases, the commercial carrier commonly drops the parcel in an unsecured area near the front entrance of a building, such as near the front porch area of a home or office. However, this practice carries the obvious liability of exposing the commercial carrier and/or the recipient to the risk that the unsecured parcel may be stolen or possibly damaged by exposure to environmental elements. In 2015, it was suggested that approximately 23 million parcels have been stolen in the United States and this number will only increase as more people order online and household staples that are being delivered have become increasingly valuable Thieves have been known to follow delivery trucks to a household and then steal the parcel.

There have been products designed to protect parcels from thieves and the environment, such as standard locking boxes that are containers with manual combination locks. However these products have no method of notifying users about what is happening with their delivery. The manual locks require delivery drivers to know the combination, which adds time and complexity to the delivery driver's job. Deliveries rely on efficiency, drivers do not want to add time to each delivery and will not use the product if it takes too much additional time when compared to a normal delivery where the parcel is just dropped off in an unsecured area near the front entrance. Because users don't get notified, they do not know the status of their parcels, such as if it has been secured in a container.

Other products take the form of disks that sit in front of someone's house. The delivery driver is meant to place the package on the disk, which arms an alarm. If the parcel is removed from the disk the user is notified and a loud alarm goes off. The issue with these types of systems is that they do not prevent the actual theft of the parcel because it is sitting out in the open. Even if the alarm goes off and brings attention to the area, the thief can simply run away with the parcel. Thus exists a need for a system and method that provides quick and accessible parcel delivery while having enhanced security and protection to a parcel that is small and light enough to be portable and placed in front of any type of home.

### SUMMARY

The disclosure presented herein relates to a parcel securing system comprising, one or more databases coupled via a network, one or more processors coupled to the one or more databases, and at least one computing device coupled to the one or more processors and the one or more databases via the network; wherein the one or more processors are configured to, collecting and storing user data related to a first user in the one or more databases, wherein the user data comprises tracking codes of one or more parcels expected by the first user, receiving, via the network, a second user request to open a parcel securing device, the parcel securing device comprising one or more sensors, a microcontroller configured to control a motor, the motor in a housing, the motor configured to extend and retract a cable or rope, the cable or rope when extended opening a container, the cable or rope when retracted closing the container, the request having an inputted code, verifying, in response to the request from the second user, that the inputted code matches the tracking codes of the one or more parcels expected by the first user, wherein if the inputted code is verified to match the tracking codes of the one or more parcels expected by the first user, allow request, unlocking, in response to the allowed request, the parcel securing device, wherein the motor extends the cable or rope, opening the container, locking, the parcel securing device wherein the motor retracts the cable or rope, closing the container, verifying that a computing device of the first user is within a predetermined distance of parcel securing device, unlocking, in response to the verification that the computing device of the first user is within a predetermined distance of the parcel securing device, wherein the motor extends the cable or rope, opening the container, detecting, by one or more sensors, while parcel securing device is unlocked, any movement of the parcel securing device, locking, in response to the parcel securing device having no detected movement by the one or more sensors for a predetermined amount of time, wherein the motor retracts the cable or rope, closing the container, presenting the location of the parcel securing device, determined by a GPS receiver on the parcel securing device, via a user interface on the computing device to the first user, generating light effects by affecting the emission of light through one or more LED on the parcel securing device, generating an alarm, in response to the parcel securing device been tampered with or moved from a predetermined area as determined by the GPS or wireless network position, scanning, by a scanner of the parcel securing device, tracking codes of the one or more parcels, the cable or rope connected to a rotatable spool within a drum in contact with the motor wherein an outer portion of the cable or rope is configured to be withdrawn from the spool while permitting an inner end of the cable or rope to be secured wherein an outer end of the cable or rope is protruding out of a hole on a side of the housing, further comprising a screw cap at the outer end of the cable or rope configured to prevent the outer end of the cable or rope from moving back into the housing.

The disclosure presented herein also relates to a parcel securing system comprising, a parcel securing device, the parcel securing device comprising one or more sensors, a microcontroller configured to control a motor, the motor in a housing, the motor configured to extend and retract a cable or rope, the cable or rope when extended allowing access to a container, the cable or rope when retracted preventing access to the container, wherein the cable or rope is enclosed within a hem of the container, the cable or rope connected to a rotatable spool within a drum in contact with the motor wherein an outer portion of the cable or rope is configured to be withdrawn from the spool while permitting an inner end of the cable or rope to be secured wherein an outer end of the cable or rope is protruding out of a hole on a side of the housing, further comprising: a screw cap at the outer end of the cable or rope configured to prevent the outer end of the cable or rope from moving back into the housing.

The disclosure presented herein also relates to a parcel securing system comprising, a parcel securing device, the parcel securing device comprising one or more sensors, a microcontroller configured to control a feeding mechanism, the feeding mechanism in a housing, the feeding mechanism having a motor, the motor configured to extend and retract a cable or rope through one or more apertures on a front and rear of the parcel securing device, wherein a length of the cable or rope is weaved within one or more eyelets of a container, the cable or rope when extended allowing access to the container, the cable or rope when retracted preventing access to the container, further comprising a pocket, the pocket configured for storing the parcel securing device within the bag, bag further comprising a handle, the bag further comprising a hook, the hook having an aperture wherein the handle is positioned through the handle, the hook having a bend configured to secure the bag to a door frame, further comprising, one or more databases coupled via a network, one or more processors coupled to the one or more databases, at least one computing device coupled to the one or more processors and the one or more databases via the network; wherein the one or more processors are configured to, collecting and storing user data related to a first user in the one or more databases, wherein the user data comprises tracking codes of one or more parcels expected by the first user, receiving, via the network, a second user request to open the parcel securing device, the parcel securing device further comprising one or more sensors, the request having an inputted code, verifying, in response to the request from the second user, that the inputted code matches the tracking codes of the one or more parcels expected by the first user, wherein if the inputted code is verified to match the tracking codes of the one or more parcels expected by the first user, allow request, unlocking, in response to the allowed request, the parcel securing device, wherein the motor extends the cable or rope, opening the container, locking, the parcel securing device wherein the motor retracts the cable or rope, closing the container, verifying that a computing device of the first user is within a predetermined distance of parcel securing device, and unlocking, in response to the verification that the computing device of the first user is within a predetermined distance of the parcel securing device, wherein the motor extends the cable or rope, opening the container.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF DRAWINGS

The present invention will be described by way of exemplary embodiments, but not limitations, illustrated in the accompanying drawings in which like references denote similar elements, and in which:

FIG. 1 depicts a block diagram of a parcel securing system.

FIG. 2 depicts the components of a computing device.

FIG. 3 depicts the parcel securing device.

FIG. 4 depicts another view of the parcel securing device.

FIG. 5 depicts the locking bar of the parcel securing device.

FIG. 6 depicts a panel of the locking bar.

FIG. 7 depicts a screw cap at the end of the metal cable.

FIG. 8 depicts the container of the parcel securing device in the open position.

FIG. 9 depicts the container of the parcel securing device in the closed position.

FIG. 10 depicts a top view of the container of the parcel securing device in the open position.

FIG. 11 depicts a top view of the container of the parcel securing device in the closed position.

FIG. 12 depicts a flowchart of one embodiment of the parcel delivery process.

FIG. 13 depicts a second embodiment of the parcel securing device.

FIG. 14 depicts the pocket of the second parcel securing device

FIG. 15 depicts the locking disc of the second parcel securing device.

FIG. 16 depicts the container of the second parcel securing device.

FIG. 17 depicts the bag of the third parcel securing device.

FIG. 18 depicts the second parcel securing device locking mechanism.

FIG. 19 depicts another view of the container of the second parcel securing device.

### DETAILED DESCRIPTION

In the Summary above and in this Detailed Description, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range including that number (which may be a range having an upper limit or no upper limit, depending on the variable being defined). For example, “at least 1” means 1 or more than 1. The term “at most” followed by a number is used herein to denote the end of a range, including that number (which may be a range having 1 or 0 as its lower limit, or a range having no lower limit, depending upon the variable being defined).

“Exemplary” is used herein to mean “serving as an example, instance, or illustration.” Any aspect described in this document as “exemplary” is not necessarily to be construed as preferred or advantageous over other aspects

Throughout the drawings, like reference characters are used to designate like elements. As used herein, the term “coupled” or “coupling” may indicate a connection. The connection may be a direct or an indirect connection between one or more items. Further, the term “set” as used herein may denote one or more of any item, so a “set of items” may indicate the presence of only one item or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skill in the art that the invention may be practiced without these specific details. In other instances, well-known features have not been described in detail to avoid unnecessarily complicating the description.

The present disclosure is generally drawn to a system and method, according to one or more exemplary embodiments, for secure parcel delivery. Parcel theft has become more common due to the rise in online retail stores. Parcel recipients are now looking for the convenience of delivery to their doorsteps without the risk of the parcels being stolen. The system secures parcels that are delivered to someone's doorstep, prevents theft, and notifies the parcel recipient when the parcel is delivered, when the box is locked and unlocked, when the parcel is moved, and other activities that may occur. The system locks the parcel in a secure container so that it cannot be stolen. If a thief does decide to steal the container, an alarm goes off, bringing attention directly to the location of the stolen parcel. GPS information of the parcel would also be sent to the user so that it can be located and retrieved. The system is also designed to be small and light enough to be taken in to the home when the parcel recipient is not expecting any parcels and can be used in situations where the user does not have ample front door space. The system allows the parcel deliverer to scan the parcel with the barcode scanner and drop the parcel in the container, adding only seconds to the delivery. The invention can also send a notification that the parcel has been delivered and is secured using a series of sensors and network interfaces

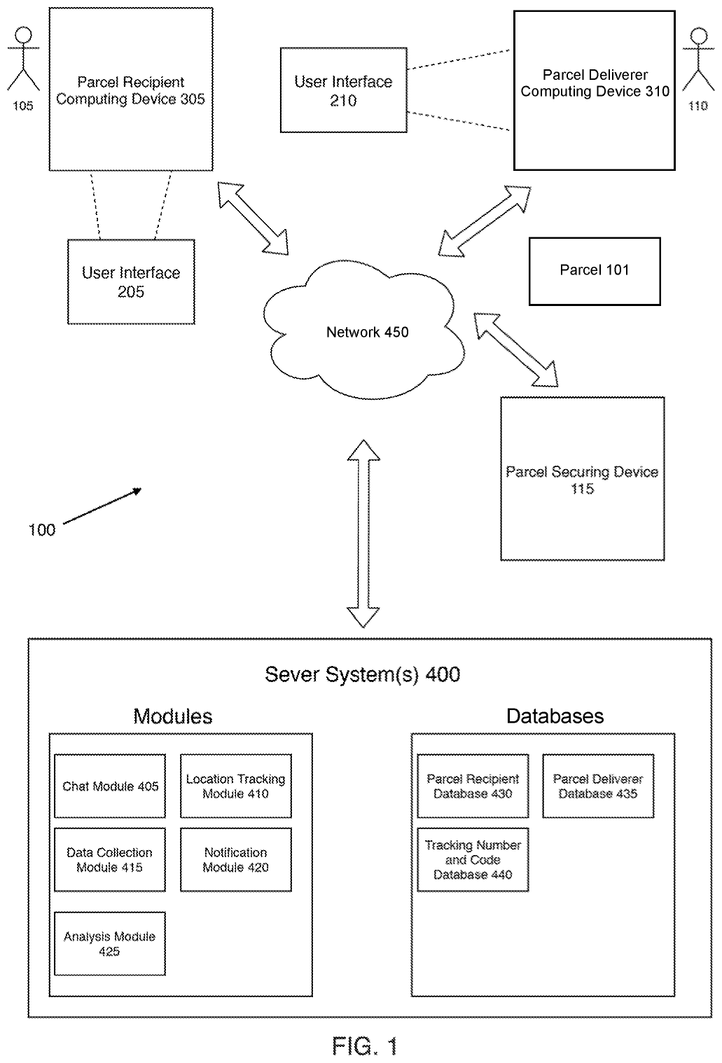

FIG. 1 is a block diagram of parcel securing system 100 constructed in accordance with the principals of the present invention. Parcel securing system 100 may include one or more parcels such as parcel 101. The word “parcel” is used herein broadly to include any item handled by delivery services, such as packages, letters, containers, or unpackaged items. Parcel securing system 100 may have one or more parcel securing devices such as parcel securing device 115 to secure parcel 101. Parcel securing system 100 may include one or more parcel recipients such as parcel recipients 105. Parcel recipient 105 may be any individual, including but not limited to the owner of parcel 101, someone who receives parcel 101, anyone who has administrative authority from the owner of parcel 101, or a third-party to access the contents of parcel 101.

Parcel securing system 100 may have one or more parcel deliverers such as parcel deliverer 110. Parcel deliverer 110 may be any delivery service provider, such as the Postal Service, UPS®, FedEx®, DHL®, or an individual working as a contractor for a company such as Amazon®. Parcel recipient 105 may have the capacity to function as a parcel deliverer 110 and parcel deliverer 110 may in return function as a parcel recipient 105. Parcel deliverer 110 may be the one delivering one or more parcels 101 having identifying information number encoded on the label, such as but not limited to a universal product barcode (UPC), tracking number, a quick response (QR) code, NFC component, or RFID tag.

Parcel recipient 105 and parcel deliverer 110 may be located in various physical locations that are either located apart or are located in the vicinity of one other. Parcel recipient 105 may access a parcel recipient user interface, such as parcel recipient user interface 205 using a parcel recipient computing device such as parcel recipient user computing device 305. Parcel deliverer 110 may access a parcel deliverer user interface such as parcel deliverer user interface 210 using a parcel deliverer computing device such as parcel deliverer computing device 310. Parcel recipient user interface 205 and parcel deliverer user interface 210 may have a plurality of buttons or icons that are selectable by parcel recipient 105 and parcel deliverer 110 for parcel securing system 100 to perform particular processes in response to the selections.

Parcel recipient computing device 305, parcel deliverer computing device 310, and parcel securing device 115 may be in communication with one or more servers 400, such as server 400 via one or more networks, such as network 450. Server 400 may be located at a data center, or any other location suitable for providing service to network 450 whereby server 400 may be in one central location or in many different locations in multiple arrangements. Server 400 may comprise a database server such as MySQL® or Maria DB® server. Server 400 may have an attached data storage system storing software applications and data. Server 400 have may a number of modules that provide various functions related to parcel securing system 100. Modules may be in the form of software or computer programs that interact with the operating system of server 400 whereby data collected in databases as instruction-based expressions of components and/or processes under parcel securing system 100 may be processed by one or more processors within server 400 or another component of parcel securing system 100 as well as in conjunction with execution of one or more other computer programs.

Server 400 may comprise a number of modules that provide various functions related to parcel securing system 100 using one or more parcel recipient computing devices 305, parcel deliverer computing devices 310, and parcel securing device 115. Modules may include a chat module such as chat module 405, a location tracking module such as location tracking module 410, a data collection module such as data collection module 415, and a notification module such as notification module 420, and an analysis module such as analysis module 425. Modules may be in the form of software or computer programs that interact with the operating system of server 400 whereby data collected in databases may be processed by one or more processors within server 400 or another component of appointment scheduling system 100 as well as in conjunction with execution of one or more other computer programs. Server 400 may comprise a number of databases, which may include a parcel recipient profile database such as parcel recipient database 430, a parcel deliverer database such as parcel deliverer database 435, and tracking number and code database 440.

Modules may be configured to receive commands or requests from parcel recipient computing device 305, parcel delivery computing device 310, parcel securing device 115, server 400, and outside connected devices over network 450. Server 400 may comprise components, subsystems, and modules to support one or more management services for parcel securing system 100.

Server 400 may run any number of algorithms to proactively respond to the conditions based on parcel recipient's 105 settings or system assumptions, such as if the battery status of locking bar 120 is lower than 10%. Server 400 may automatically communicate with locking bar 120 to switch to a power save mode whereby parcel 101 may still be retrieved but some of the other features may not be utilized. If the authentication of inserted verification codes fail more than twice or a predetermined number of times within a set timeframe, server 400 may automatically report the authentication failure to parcel recipient 105 or a system administrator or prevent any further codes from being verified until parcel recipient 105 returns home. In this case, the system assumes locking bar 120 is being sabotaged or parcel recipient 105 is in need of assistance

In one or more non-limiting embodiments, network 450 may include a local area network (LAN), such as a company Intranet, a metropolitan area network (MAN), or a wide area network (WAN), such as the Internet or World Wide Web. Network 450 may be a private network or a public network, or a combination thereof. Network 450 may be any type of network known in the art, including a telecommunications network, a wireless network (including Wi-Fi), and a wireline network. Network 450 may include mobile telephone networks utilizing any protocol or protocols used to communicate among mobile digital computing devices (e.g. computing device 104), such as GSM, GPRS, UMTS, AMPS, TDMA, or CDMA. In one or more non-limiting embodiments, different type of data may be transmitted via network 450 via different protocols. In other non-limiting embodiments, parcel recipient computing device 305 and parcel deliverer computing device 310 may act as standalone devices or whereby they may operate as peer machine in a peer-to-peer (or distributed) network environment.

Network 450 may further include a system of terminals, gateways, and routers. Network 450 may employ one or more cellular access technologies including 2nd (2G), 3rd (3G), 4th (4G), 5th (5G), LTE, Global System for Mobil communication (GSM), General Packet Radio Services (GPRS), Enhanced Data GSM Environment (EDGE), and other access technologies that may provide for broader coverage between computing devices if, for instance, they are in a remote location not accessible by other networks.

Parcel recipient computing device 305 and parcel deliverer computing device 310 may be any type of computing device that typically operates under the control of one or more operating systems which control scheduling of tasks and access to system resources. Parcel recipient computing device 305 and parcel deliverer computing device 310 may comprise hardware components that allow access to edit and query parcel securing system 100.

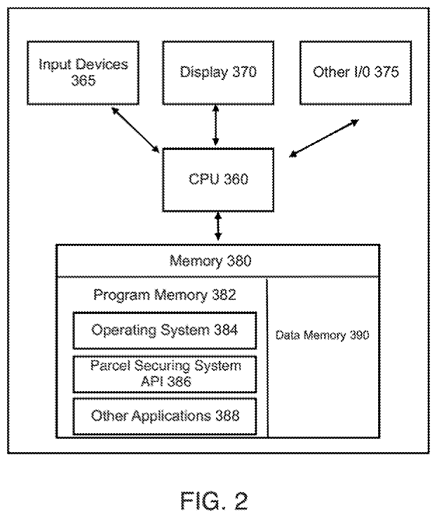

Parcel recipient computing device 305 and parcel deliverer computing device 310 may be a type of computing device that is detailed in FIG. 2. Parcel recipient computing device 305 and parcel deliverer computing device 310 may comprise hardware components that allow access to edit and query parcel securing system 100. Parcel recipient computing device 305 and parcel deliverer computing device 310 may include one or more input devices, such as input devices 365, that provide input to a CPU (processor), such as CPU 360, notifying it of actions. The actions may be mediated by a hardware controller that interprets the signals received from input device 365 and communicates the information to CPU 360 using a communication protocol. Input devices 365 may include but are not limited to a mouse, a keyboard, a touchscreen, an infrared sensor, a touchpad, a wearable input device, a camera- or image-based input device, a microphone, or other user input devices known by those of ordinary skill in the art.

CPU 360 may be a single processing unit or multiple processing units in a device or distributed across multiple devices. CPU 360 may be coupled to other hardware devices, such as one or more memory devices with the use of a bus, such as a PCI bus or SCSI bus. CPU 360 may communicate with a hardware controller for devices, such as for a display 370. Display 370 may be used to display text and graphics. In some examples, display 370 provides graphical and textual visual feedback to a user. In some implementations, display 370 may include an input device 365 as part of display 370, such as when input device 365 is a touchscreen or is equipped with an eye direction monitoring system. In some implementations, display 370 is separate from input device 365. Examples of display 370 include but are not limited to: an LCD display screen, an LED display screen, a projected, holographic, virtual reality display, or augmented reality display (such as a heads-up display device or a head-mounted device), a wearable device such as electronic glasses or contact lenses capable of computer-generated sensory input and displaying data, and so on. Other I/O devices such as I/O devices 375 may also be coupled to the processor, such as a network card, video card, audio card, USB, FireWire or other external device, camera, printer, speakers, CD-ROM drive, DVD drive, disk drive, or Blu-Ray device.

CPU 360 may have access to a memory such as memory 380. Memory 380 may include one or more of various hardware devices for volatile and non-volatile storage and may include both read-only and writable memory. For example, memory 380 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory 380 is not a propagating signal divorced from underlying hardware; a memory is thus non-transitory. Memory 380 may include program memory such as program memory 382 capable of storing programs and software, such as an operating system such as operating system 384, parcel securing system API such as parcel securing system API 386, and other computerized programs or application programs such as application programs 388. Memory 380 may also include data memory such as data memory 390 that may include database query results, configuration data, settings, user options or preferences, etc., which may be provided to program memory 382 or any element of user computing device 301.

Parcel recipient computing device 305 and parcel deliverer computing device 310 may, in some embodiments, be mobile computing devices such as an iPhone, Android-based phone, or Windows-based phone, however, this is non-limiting and they may be any computing device such as a tablet, television, desktop computer, laptop computer, gaming system, wearable device electronic glasses, networked router, networked switch, networked bridge, or any computing device capable of executing instructions with sufficient processor power and memory capacity to perform operations of parcel securing system 100 while in communication with network 450. Parcel recipient computing device 305 and parcel deliverer computing device 310 may have location tracking capabilities such as Mobile Location Determination System (MLDS) or Global Positioning System (GPS) whereby they may include one or more satellite radios capable of determining the geographical location of a computing device.

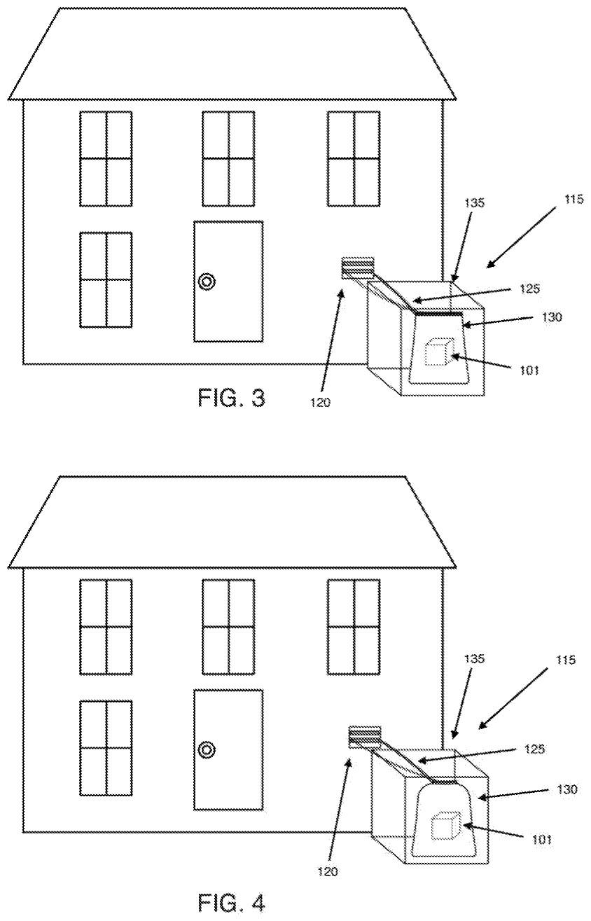

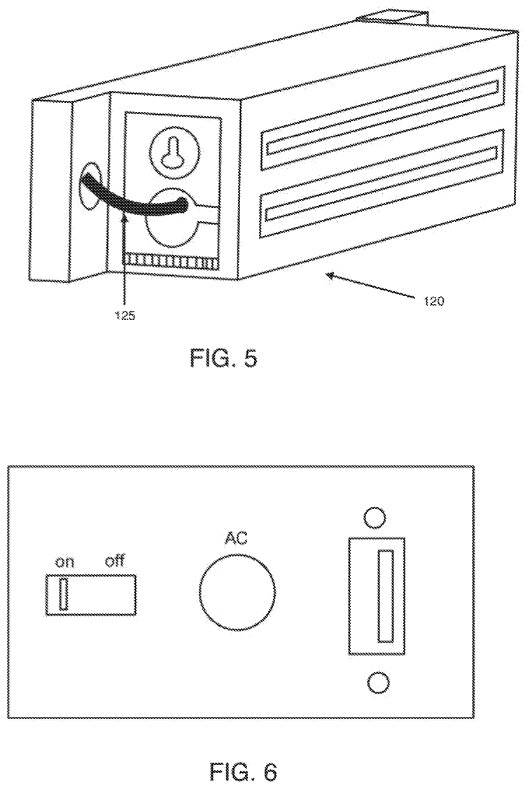

One embodiment of parcel securing device 115, is illustrated in FIG. 3 and FIG. 4. Parcel securing device 115 may have a locking bar such as locking bar 120, a metal cable such as metal cable 125, a container such as container 130 for holding parcel 101, and a storage box such as storage box 135 to place container 130 in. As illustrated in FIG. 5, Locking bar 120 may have one or more apertures to provide access for a length of metal cable 125 to exit and return into locking bar 120. Locking bar 120 may be comprised of a housing that protects the electronics and allows locking bar 120 to be mounted to a box or other fixed surface structure to prevent it from being removed without authorization, such as the outer walls of a home. The housing is generally of an elongated rectangular form with a left side surface, right surface, exterior surface, and interior surface having a rugged and durable structure and presenting a pleasing and practical exterior. The housing is typically made of metal but may be made of any material that does not stray from the intention of the present invention. The electronic and mechanical components are positioned inside of the housing. Holes on the housing will allow it to be mounted with nuts and bolts to any box or surface.

Locking bar 120 may include a keyhole and a key on the right-side surface in case the system has malfunctioned and in need of repair, or parcel recipient 105 wishes to manually access the contents inside of locking bar 120 or detach metal cable 125 to remove parcel 101 from within container 130. The keyhole may be configured with a certain width, length, and depth, to accommodate different types of keys. The key may be any device that can open a lock, door, gate, or means of access.

In one or more non-limiting embodiments, locking bar 120 may have a motor mechanism, control system, communication system, sensor system, and power system. The power system of locking bar 120 provides the energy to power the motor, sensor system, the circuits, and components of the control system during the process of delivery and retrieving a parcel. Locking bar 120 may be powered by methods known by those of ordinary skill in the art. In some embodiments, locking bar 120 may plug into an electrical outlet using an electrical cord to supply power to the motor, sensor system, and control system. As illustrated in FIG. 6, locking bar 120 may have a small switch inside of the housing to power on or off the entire parcel securing device 115 whereby a user may unlock the door, open it up and push the switch to the on position or off position. Locking bar 120 may also have a power outlet and one or more interface ports. Further, locking bar 120 may include a rechargeable battery pack mounted inside of the housing whereby the reachable battery is of a charge, design, and capacity to provide sufficient power to the motor, sensor system, and control system while operating for a set period of time needed for the delivery and retrieval of parcels.

Locking bar 120 may connect to a power source such as an outlet by a power cord. Locking bar 120 may also connect to a charging station capable of recharging the rechargeable battery pack mounted inside of the housing. The charging station may include any suitable connection allowing a user to connect locking bar 120 to the charging station. The connection may be power cords so that a user may connect locking bar 120 to the charging station in order to charge the rechargeable battery. In another aspect, the connection may be a docking station with a charging station specifically sized and shaped to be connectable to locking bar 120. In other embodiments, the connection may be a wireless charger, which transfers energy from the charger to a receiver in locking bar 120.

Locking bar 120 may include a scanner or sensor capable of detecting and decoding parcel tracking numbers and other passcodes. The sensor or scanner may include an optical or laser reader capable of reading barcodes or quick response (QR) codes, as well as NFC and radio frequency (RFID) tags. Locking bar 120 may communicate with other devices via communication links, such as USB (Universal Serial Bus) or HDMINGA (High-Definition Multimedia Interface/Video Graphics Array). Locking bar 120 also may include local wireless circuitry, which may enable short-range communication to another device. The local wireless circuitry could communicate on any wireless protocol, such as infrared, Bluetooth, IEEE 902.11, or some other local wireless communication protocol.

The sensor system may include a plurality of detectors mounted to the housing of locking bar 120 or container 130 in the form of standard infrared (“IR”) detectors having photodiode and related amplification and detection circuitry. In other embodiments, radio frequencies, magnetic fields, and ultrasonic sensors and transducers may be employed. Detectors may be arranged in any number of configurations and arrangements. For example, locking bar 120 may include an omnidirectional detector mounted to the top and bottom of locking bar 120 to detect signals from a 360-degree field of view. In other embodiments, various detectors may be mounted on the side of locking bar 120 which may be used to form a collective field of view of detection.

The sensor system may comprise one or more sensors to detect when locking bar 120 is being tampered with, including a temperature sensor, a pressure sensor, an accelerometer or other type of sensor. The sensors of the sensor system may be coupled to the control system such that locking bar 120 may communicate with server 400 or parcel recipient computing device 305 and parcel deliverer computing device 310. For instance the one or more accelerometers may measure change in acceleration of parcel securing device 115. Accelerometers may track the motion of parcel securing device 115 to determine what action is occurring, such as if parcel securing device 115 is being picked up, dropped, or moved, whereby the accelerometer may register acceleration in certain patterns and notify the control system. Sensors may include sensors within locking bar 120. Alternatively, sensors can detect when parcel securing device 115 is removed a certain distance from parcel recipient's 105 household.

In one or more non-limiting embodiments, the sensor system may include tension force sensors, designed for the measurement of tensile load, weight, and force in the motor to measure the tension in metal cable 125, whereby the tension force sensors may be used to detect if something is caught in the opening of container 130 for safety purposes.

Locking bar 120 may include a control system in the form of a circuit board, a memory or other non-transient storage medium in which computer-readable coded instructions are stored, and one or more processors configured to execute the instructions stored in the memory. The circuit board may have a microcontroller to store and run the needed programs on the software application. Locking bar 120 may have a wireless transmitter, a wireless receiver, and a related computer process executing on the processors.

The control system may have one or more computing devices that may be integrated into locking bar 120, while in other non-limiting embodiments, computing systems may be remotely located computing systems or server 400 configured to communicate with one or more locking bars 120. The microcontroller acts as a servo control mechanism capable of receiving input from server 400 or one or more sensors, sending input to server 400, analyzing the input from server 400, and generating an output signal to the motor. The microcontroller may have an on-board memory to control the power that is applied to the motor. The microcontroller may receive signals from the motor, power system, and sensor system, such as whether any of the components in the various systems need to be replaced or if the objective is accomplished.

Locking bar 120 may also have a global positioning system (GPS) receiver to provide location information in the form of GPS coordinates that may be sent by notification module 420 to parcel recipient computing device 305 to prevent theft by someone attempting to remove the entire parcel securing device 115 from a household or other designated location. In one or more non-limiting embodiments, locking bar 120 may have a touchpad display to present information and receive input from a parcel deliverer 110 or parcel recipient 105 through a virtual keyboard.

Locking bar 120 may have a communication system so that locking bar 120 may communicate with other system components, such as server 400, parcel recipient computing device 305, parcel deliverer computing device 310, and parcel securing device 115, connected to network 450 whereby parcel recipient 105 may remotely control all the features of locking bar 120 remotely and receive notifications on activity about locking bar 120.

Locking bar 120 may include an output device, such as an alarm speaker, for indicating whether parcel securing device 115 has been tampered with or moved from its proper location as determined by the GPS or wireless network position. In one or more embodiments, locking bar 120 may transmit a signal through the communication system to server 400 whereby notification module 420 transmits to parcel recipient computing device 305 or personal email that an alarm has been initiated.

In some embodiments, locking bar 120 may include one or more light emission devices such as a light-emitting diode (LED) and associated circuitry for generating various light effects by affecting the emission of light through the LED. The LED may be used to attract attention to locking bar 120 and provide diagnostic information about locking bar 120. For instance, if locking bar 120 is being stolen, the LED may light up with the alarm to attract attention. If there is an error or warning, the lights may change color or change flashing pattern to indicate the type of error or warning.

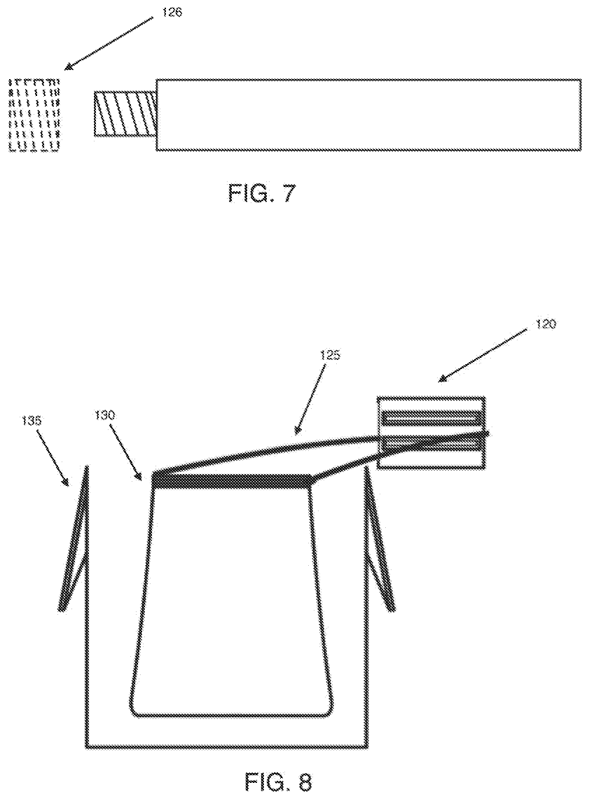

Metal cable 125 may be made of any metallic material, however this is non-limiting and metal cable 125 may be made of any flexible cut-resistant material such as a manufactured fiber. Metal cable 125 may be connected to a spool wrapped around a motor inside of the housing of locking bar 120 whereby an outer portion of the length of metal cable 125 may be withdrawn from a spool while permitting the inner end of the length of metal cable to be secured at all times whereby the other end is protruding out of the hole on one side of the metal housing. The end of metal cable 125 protruding outside of locking bar 120 may have a screw cap such as screw cap 126 on the end of metal cable 125 as illustrated FIG. 7.

The spool may be rotatably mounted within locking bar 120 while the drum may be held in a stationary position within locking bar 120 whereby the spool may be rotated within locking bar 120 in a clockwise or counter-clockwise rotation relative to the drum. The spool may be connected to a motor, the motor having a drive member extending from the motor thereof into contact with the spool and directly reciprocate the spool within a drum provided in locking bar 120 whereby rotational energy produced by the motor is converted to linear movement of metal cable 125 to enlarge and decrease the opening to container 130. The motor may be attached to the housing of locking bar 120 by fasteners such as bolts, latches, screws, or any other fasteners well known to those skilled in the art. The motor operates by providing a torque that rotates the spool.

Metal cable 125 may be designed of a material to straighten out when leaving the spool. Metal cable 125 will begin to withdraw from the spool located inside locking bar 120 when the spool rotates in a counterclockwise direction to play out the outer portion of the length of metal cable 125. As the spool rotates, it carries with it the inner turns of metal cable 125 but as it proceeds to rotate relative to the spool receptacle, the innermost turn of the inner portion of the length of metal cable 125 leaves its position and extends outward of locking bar 120.

Metal cable 125 may be designed similar to a zip tie with angled notches and the opening of locking bar 120 where metal cable 125 comes out may have a pin like a zip tie as well. The opening of locking bar 120 may be fitted with a pin or gasket for preventing container 130 to be manually pulled open and damaging the motor that extends and retracts metal cable 125.

Container 130 may be a bag or bag like apparatus comprised of a first side and second side with a bottom defined by a folded edge whereby when the first side and second side are separated an opening is formed at the top of container 130. The first side, second side, and bottom may be sealed using methods known by those of ordinary skill in the art. The interior and exterior of container 130 may be fabricated in a manner which enables container 130 to remain flexible yet provides a significant amount of security by preventing cutting through container 130 to the interior of container 130 for access of parcel 101 inside. Specifically, the interior of container 130 may be comprised of layers of foldable material of cut-resistant material that may be metallic or synthetic. The various types of construction of containers are well-known in the art and the particular method of manufacture is not intended to limit the present invention in any way.

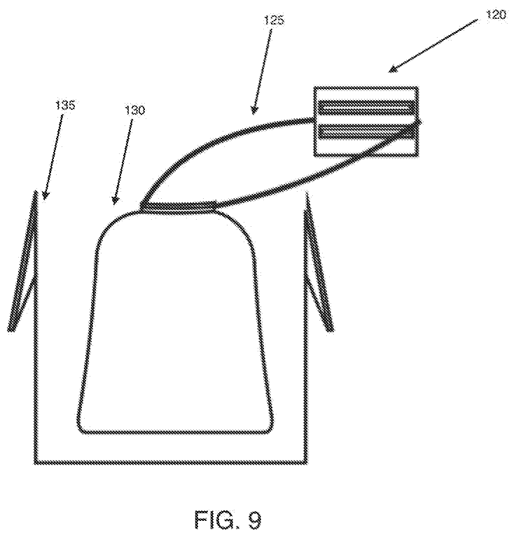

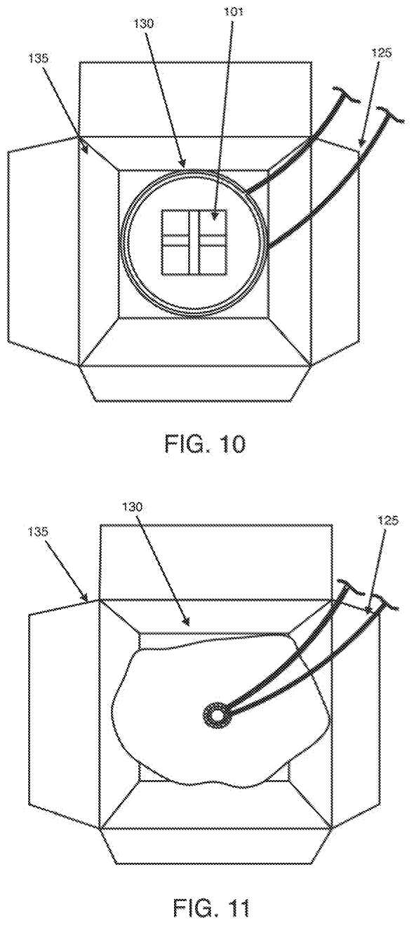

To connect container 130 to locking bar 120, the door on the right side of locking bar 120 may be unlocked with a key. Screw cap 126 on the end of metal cable 125 may be removed. Metal cable 125 may then be threaded through one or more holes in or proximate to the opening of container 130 so that when metal cable 125 tightens, the opening at the top of container 130 closes. The end of metal cable 125 is then threaded through the hole in the door on the side of locking bar 120. Screw cap 126 on the end of metal cable 125 is then reapplied so that when metal cable 125 is pulled, screw cap 126 prevents metal cable 125 from sliding back through the hole in the door on the side of locking bar 120. The door on locking bar 120 may then be closed and locked. When assembled, parcel securing device 115 allows the motor to receive a signal from the microcontroller to extend metal cable 125, causing container 130 to open as illustrated in FIG. 8, and for the motor to receive a signal from the microcontroller to retract metal cable 125, causing container 130 to close as illustrated in FIG. 9. When container 130 is opened as illustrated in FIG. 10, parcel 101 may be placed or removed from container 130. When container 130 is closed, as illustrated in FIG. 11, parcel 101 may be secured in container. 130.

In some embodiments, the first and second side of container 130 may be folded and sealed to form hems. Metal cable 125 may be enclosed within the hem of container 130. One or more hem seals may run the width of container 130 as well as the corners of container 130 with metal cable 125 within the hems. The seals must be of sufficient strength and durability to allow for movement of metal cable 125 within the hem without breaking or dislodging as well as being picked up and moved by parcel recipient 105 or parcel deliverer 110. In some embodiments, metal cable 125 may be incorporated or integrated with container 130. In other non-limiting embodiments, metal cable 125 may be positioned through one or more apertures near the top of container 130 such that when metal cable 125 is retracted, the sides of container 130 come closer together and the opening of container 130 is closed. In further embodiments, container 130 may have a zipper mechanism whereby the motor may pull the zipper open and close. The zipper may have a series of teeth and a slider connected to the teeth that pulls the teeth open or apart. The slider may be attached to a pull which may be connected to the motor to move the slider up and down the teeth.

In yet another embodiment metal cable 125 may be positioned through one or more apertures near the top of container 130 such that when metal cable 125 is retracted, the sides of container 130 come closer together until an electromagnetic lock connected to one side of the inner surface of container 130 comes into contact with the locking bar 120 or another locking apparatus whereby a signal is received from server 400 to unlock or lock container 130.

Storage box 135 may include a base and sidewalls projecting upwardly and outwardly from the base of storage box 135 until forming an opening. The opening may be square, rectangular, circular, oval, triangle, trapezoid, octagon, or hexagon in shape.

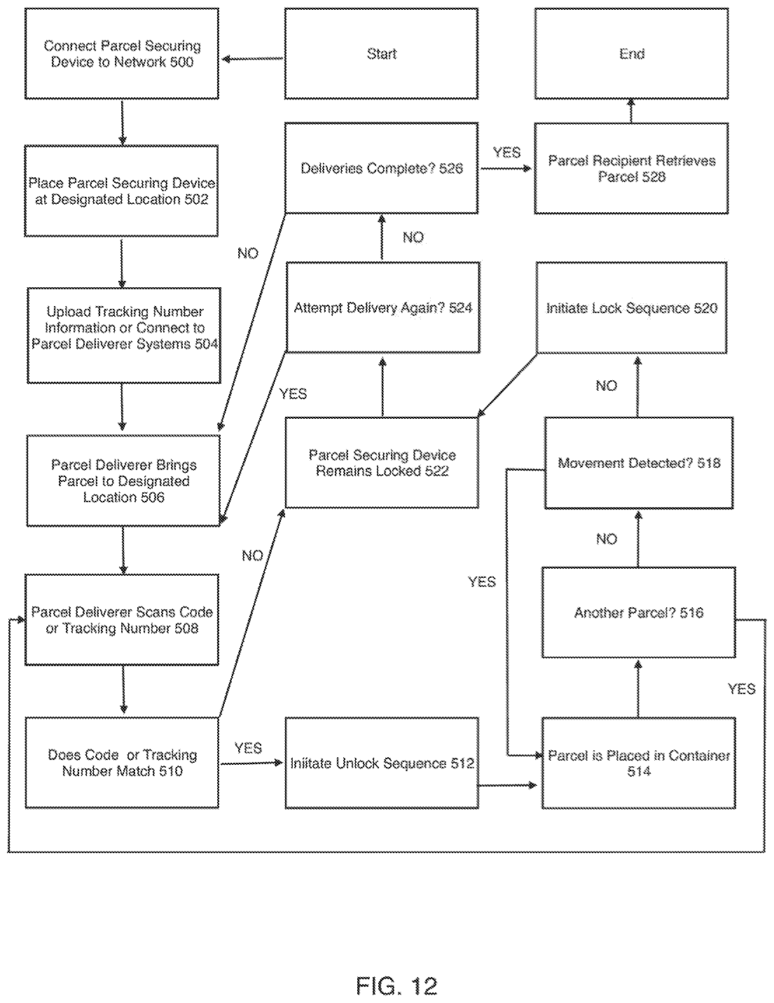

FIG. 12, depicts a flow diagram showing an embodiment of an exemplary method for implementing parcel securing system 100. One or more exemplary method steps may be performed by components included in FIG. 1, such as, without limitation, parcel recipient computing device 305, parcel deliverer computing device 310, server 400, and parcel containment device 115 over network 450.

Parcel recipient 105 may initially register to become a registered user associated with parcel securing system 100 and parcel securing system API 386. Parcel securing system API 386 may be downloadable and installable on parcel recipient computing device 305 through an API. In one or more non-limiting embodiments, parcel securing system API 386 may be preinstalled on parcel recipient computing device 305 by the manufacturer or designer. Further, parcel securing system API 386 may be implemented using a web browser via a browser extension or plugin.

Upon initially signing up with parcel securing system 100 through parcel securing system API 386, parcel recipient 105 may be prompted to provide an email address, name, username, password, phone number, address, and any other personal information. In one or more non-limiting embodiments, location of parcel recipient 105 may be verified by location tracking module 410 using the global positioning system (GPS) capabilities of parcel recipient computing device 305. Notification module 420 may generate a code that is transmitted to parcel recipient's 105 selected email or parcel recipient computing device 305 by text message whereby parcel recipient 105 may verify their account by entering the generated code into a text block window. When registering with parcel securing system 100, parcel recipient 105 may also be able to log into parcel securing system 100 using login credentials from other social media applications, such as Facebook® or Instagram® or similar applications known by those of ordinary skills in the art. This is advantageous for parcel recipients 105 who do not wish to have to learn or provide multiple login information.

Parcel recipient 105 may authorize parcel securing system 100 access to third party service providers such as delivery service providers that may be but not limited to the Postal Service, UPS®, FedEx®, and DHL®. In one or more non-limiting embodiments, parcel recipient 105 may be required to provide credentials to the third-party service provider to allow access by parcel securing system 100. Parcel recipient 105 may also authorize third-party service providers whereby when a third-party service is linked to parcel securing system 100, access may be granted to various accounts of parcel recipient 105 and importing of data from those accounts may occur, such as to import one or more purchasing accounts. If parcel recipient 105 authorizes access, data collection module 415 collects or otherwise accesses purchasing accounts and stores the information in parcel recipient profile database 430.

Parcel recipient 105 may opt-in for various parcel securing system 100 notifications to be transmitted by notification module 420. Parcel recipient 105 may opt-in to allow parcel securing system 100, through parcel securing system API 386, to notify parcel recipient 105 when certain events occur, such as events related to parcels 101 of parcel recipient 105.

Parcel recipient user interface 205 may include a screen displaying a drop down list related to events whereby notification module 420 may retrieve notifications associated with parcel recipient 105 whereby notification module 420 may apply this data to provide notifications pertaining to parcel recipient 105 whereby a status indicator may appear to notify parcel recipient 105 when one or more notifications have occurred.

In some embodiments, user interface 205 and 210 may include a chat screen for displaying a chat messaging interface, generated by chat module 405 to parcel recipient 105 and parcel deliverer 110. In one or more non-limiting embodiments, the chat messaging interface displayed to parcel deliverer 110 has controls through user interface 210 that allow parcel deliverer 110 to establish a chat session with a parcel recipient 105 to assist in the delivery process.

In user interface 205 and 210, parcel recipient 105 may be represented by a virtual map of the geographical location of parcel securing device 115. The virtual map may have geography and topography, which parallels the geography and topography of the physical real world. For instance, a range of longitudinal and latitudinal coordinates defining a geographic area or space in the real world may be mapped to a corresponding range of longitudinal and latitudinal coordinates defining a virtual space on the virtual map as well as each individual coordinate in the range. The graphical map may be displayed with parcel securing device 115 displayed as a picture, markers, pins, or identifiers at its respective location.

Parcel securing device's 115 position on the virtual map corresponds to its position in the real world. For instance, a parcel securing device 115 may be located at the corner of Oak and Cherry in the real world, which has a corresponding position on the virtual map pertaining to the corner of Oak and Cherry. Location tracking module 410 may analyze the location of parcel securing device 115 from the GPS as it navigates the range of geographic coordinates in the real world, such as when it is being stolen by a thief or transported safely by a third-party.

Parcel deliverer 110 may initially register to become a registered user associated with parcel securing system 100. Parcel securing system 100 may be downloadable and installable on parcel deliverer computing device 310 through parcel securing system API 386. In one or more non-limiting embodiments, parcel securing system 100 may be preinstalled on parcel deliverer computing device 310 by the manufacturer or designer. Further, parcel securing system 100 may be implemented using a web browser via a browser extension or plugin.

Upon initially signing up with parcel securing system 100 through parcel securing system API 386, parcel deliverer 110 may be prompted to provide an email address, their name, username, password, phone number, address, and any other personal information. In one or more non-limiting embodiments, the location of parcel deliverer 110 may be verified by location tracking module 410 using the global positioning system (GPS) capabilities of parcel deliverer computing device 310. Notification module 420 may then generate a code that is transmitted to parcel deliverer 110 selected email or parcel deliverer computing device 310 by text message whereby parcel deliverer 110 may verify their account by entering the generated code into a text block window. When registering with parcel securing system 100, parcel deliverer 110 may also be able to log into parcel securing system 100 using login credentials from other applications or sources, such as their workplace enterprise.

Parcel deliverer 110 may authorize parcel securing system 100 to access to third-party service providers. In one or more non-limiting embodiments, parcel deliverer 110 may be required to provide credentials to the third-party service provider to allow access by parcel securing system 100. Parcel deliverer 110 may also authorize third-party service providers whereby when a third-party service is linked to parcel securing system 100, access may be granted to various accounts of parcel deliverer 110 and importing of data from those accounts may occur such as to import one or more purchasing accounts. If parcel deliverer 110 authorizes access, data collection module 415 collects or otherwise accesses purchasing accounts and stores the information in parcel deliverer database 435.

At step 500, the method may include parcel recipient 105 connecting locking bar 120 to network 450. A user interface may be provided through API 386 in order to provide instructions for connecting locking bar 120 to network 450. Locking bar 120 may broadcast a temporary Wi-Fi network such as “Locking bar” network during the initial setup process. The temporary network provides a convenient means for allowing locking bar 120 to communicate with parcel recipient computing device 305 before parcel recipient computing device 305 is connected to the available wireless network. Parcel recipient 105 may connect to “Locking bar” network through ordinary means and then return to parcel securing system API 386 to complete the setup process whereby user interface 205 may present confirmation that parcel recipient computing device 305 is connected to or paired to locking bar 120.

In some embodiments, computing device or locking bar 120 may generate an audio and/or visual indicator to inform parcel recipient 105 that parcel recipient computing device 305 and locking bar 120 have been successfully connected or paired. User interface 205 may then instruct parcel recipient 105 to select a desired network whereby a list of available wireless networks in range of parcel recipient are generated and displayed. This allows parcel recipient to select an available wireless network, such as “Parcel recipient's Household” network, that locking bar 120 may use to connect to network 450. Upon selecting an available wireless network, parcel recipient user interface 205 may display parcel securing system API 386, whereby parcel recipient 105 may enter the password for connecting to the selected available wireless network in a text entry field. These credentials may be sent by parcel securing system API 386 to locking bar 120 so that locking bar 120 may gain access to the available wireless network and thus connect to network 450 of parcel securing system 100. After parcel securing device 115 is connected to network 450, parcel securing device 115 may be positioned at the designated location ready to receive parcels, at step 502.

At step 504, the method may include parcel recipient 105 upload information pertaining to expected parcels 101 or associated information from parcels 101 may be collected by data collection module 415 from third-party service providers that parcel recipient 105 has synchronized or otherwise connected through parcel securing system API 386. Associated information pertaining to parcel 101 including tracking numbers and codes may then be stored in tracking number and code database 440.

At step 506, the method may include parcel deliverer 110 transporting parcel 101 to parcel recipient's 105 household or locking bar 120 location. At step 508, a code such as a universal product barcode (UPC), a quick response (QR) code, an NFC component, or RFID tag on parcel 101 may be scanned by the optical scanner laser reader present on locking bar 120. In some embodiments, parcel deliverer 110 may manually input tracking numbers into parcel securing system API 386 or through a connected touchscreen. After the scanning process has been completed and the images of the codes are sent by the communications system on locking bar 120 stored on tracking number and code database 440, analysis module 425 performs a code recognition process on the scanned images and a determination is made whether the scanned code is a valid code and if this exact parcel recipient 105 is expecting parcel 101 such that parcels 101 are not shipped to the incorrect recipient at step 510. In some embodiments, the code may be manually entered on the touchpad display, which is then communicated with server 400. If the tracking number is invalid, the speaker may output a prerecorded message saying that the tracking number was invalid and check to see if parcel 101 is the correct parcel 101.

At step 512, the method may include initiating the unlocking sequence if the detected, scanned, or entered code matches the stored code on tracking number and code database 440 on server 400. Locking bar 120 is unlocked by an incoming transmission sent by server 400 and received by the communication system. When locking bar 120 is unlocked, the microcontroller may then send a signal to the motor, commanding the motor to extend metal cable 125 causing container 130 to open. As locking bar 120 moves toward opening container 130 fully, the microcontroller may perform an integration of the distances to send a signal to the motor to smoothly increase and decrease the speed of metal cable 125 as container 130 becomes fully extended.

If the detected, scanned, or entered code does not match the stored code on tracking number and code database 440 on server 400, parcel securing device may remain locked at step 522 whereby another delivery attempt may be made at step 524. If parcel recipient 105 has not programmed locking bar 120 to accept parcel 101, locking bar 120 remains locked. If not, delivery attempt has failed, whereby parcel 101 may be returned by parcel deliverer 110 to the distribution center or hub and another attempt to deliver parcel 101 may be made at a later time, repeating the process until parcel 101 has been delivered or a determination has been made not to attempt further deliveries.

After confirming the validity of the code scanned and locking bar 120 unlocking, locking bar 120 may transmit a signal through the communication system to server 400 whereby notification module 420 transmits to parcel recipient computing device 305 or personal email that parcel securing device 115 is being opened and parcel 101 is being delivered.

At step 514, parcel 101 is then placed inside of unlocked container 130 by parcel deliverer 110. At step 516, it is determined if parcel deliverer has another parcel 101. After parcel 101 has been placed in container 130, parcel deliverer 110 may scan another code to initiate another subroutine starting at step 508. In other embodiments, parcel deliverer 110 may scan another code after the locking sequence has finished. When parcel deliverer 110 has completed placing parcels 101 inside container 130, the sensor system including one or more accelerometers may detect that there has been no movement status change directionally or vibrationally such that parcel securing device 115 has not moved for a certain amount of time, such as 5 seconds, whereby a signal is then sent to the microcontroller of the control system, at step 518.

The microprocessor sends a signal to the motor to spool in metal cable 125, thus once again closing locking bar 120, at step 520. Locking bar 120 may transmit a signal through the communication system to server 400 whereby notification module 420 transmits to parcel recipient computing device 305 or personal email that parcel securing device 115 has been closed and locked. At step 522 parcel securing device 115 may remain locked ready for another parcel 101 to be delivered. If there is another delivery attempt at step 524 or if it is determined there is another delivery from the same or different parcel deliverer 110 at step 526, another subroutine starting at step 506 may be initiated.

At their convenience, parcel recipient 105 may unlock container 130 at step 528 and retrieve parcel 101. Parcel recipient 105 may insert a manual code or unlock parcel securing system API 386 and retrieve parcel 101. In one or more non-limiting embodiments, location tracking module 410 may determine that parcel recipient computing device 305 is in proximity to parcel securing device 115 and send a signal to microcontroller to send a signal to the motor to extend metal cable 125, unlocking container 130 and allowing parcel recipient 105 to retrieve parcel 101. After parcel 101 has been retrieved from container 130. the sensor system including one or more accelerometers detect that there has been no status change directionally or vibrationally such that parcel securing device 115 has not moved for a certain amount of time and sends a signal to the microcontroller of the control system. The microprocessor sends a signal to motor to spool in metal cable 125, thus once again closing locking bar 120. Locking bar 120 may transmit a signal through the communication system to server 400 whereby notification module 420 transmits to parcel recipient computing device 305 or personal email that parcel securing device 115 has been closed and locked. Parcel securing device 115 is then left in a state ready for another routine.

There may be situations in which parcel deliverer 110 fails to open locking bar 120. This may be a software or hardware problem or other issue. In such situations, parcel deliverer may notify parcel recipient 105 via chat interface on parcel securing system API 386. Parcel recipient may then, using parcel recipient computing device 305, access parcel recipient user interface 205 and select an unlock function. This may send a command to unlock parcel securing device 115. Similar functionality may be added whereby a system manager or managing servers may send an unlock signal to locking bar 120.

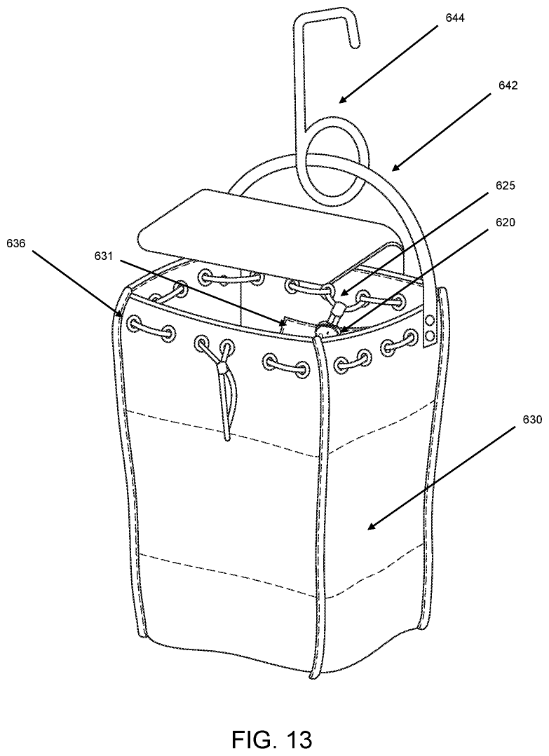

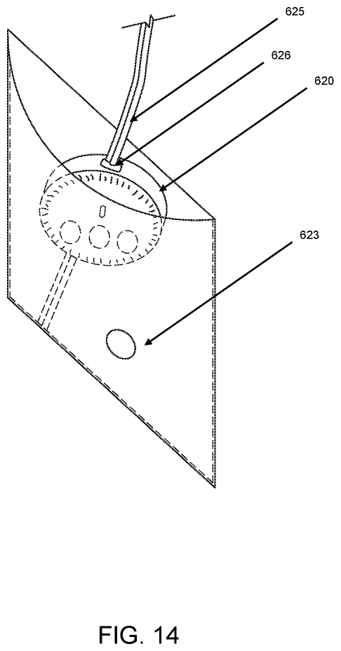

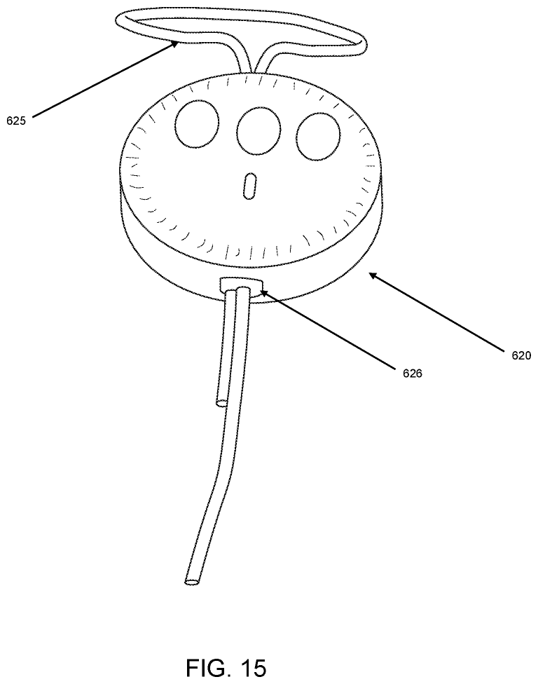

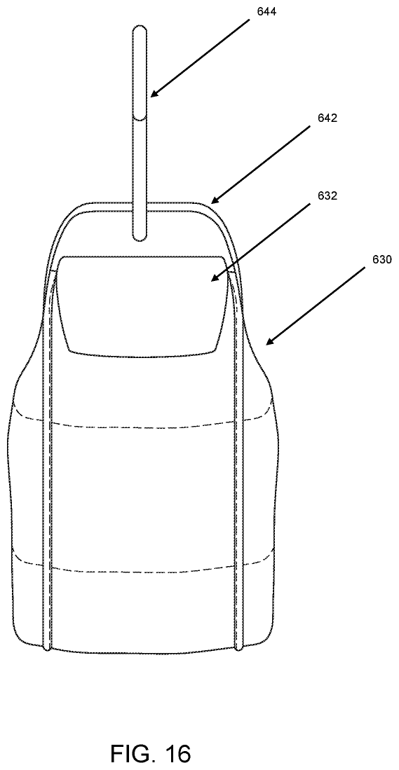

Another embodiment of parcel securing device 115 is illustrated in FIG. 13. Parcel securing device 115 may have a locking disc 620, a metal cable 625, a container 630 whereby a pocket 631 is contained within container 630, pocket 631 designed for holding parcel 101. Locking disc 620 may operate similarly and have similar components to locking bar 120 including a sensor system, control system, communication system, power system, communication system, GPS, alarm speaker, light emission devices, wireless transmitter, wireless receiver, and touchpad display. Locking disc 620 may be comprised of a housing that protects the electronical and mechanical components inside. The housing may have a cylindrical disc shape with a top surface, bottom surface, exterior surface, and interior surface having a rugged and durable structure and presenting a pleasing and practical exterior. As illustrated in FIGS. 14 and 15, Locking disc 620 may have one or more apertures 626 in the front and the back to provide access for one or more lengths of metal cable 625 to enter and exit through locking disc 620 out the front and back.

Locking disc 620 may have a cable feeding mechanism connected to the control system. The cable feeding mechanism may have a motor that feeds metal cable 625 through loading disc 620 such that two lengths of metal cable 625 extends from apertures 626 of locking disc 620. The cable feeding mechanism may have one or more rollers to selectively engage metal cable 625 and to assist in feeding two lengths of metal cable 625 out of locking disc 620 in a linear direction. The rollers may have a high coefficient of friction. The rollers prevent the movement of metal cable 625 by the friction generated between the rollers and metal cable 625. When feeding of metal cable 625 is needed, the motor is actuated such that the rollers rotate in a clockwise or counterclockwise direction. The rollers then frictionally urge or drive metal cable 625 through locking disc 620.

In some embodiments, the cable feeding mechanism may have one or more clamping wedges or other mechanisms that move inward whereby the inner surfaces of the clamping wedges frictionally engage with metal cable 625 preventing linear movement of metal cable 625. In some non-limiting embodiments, textures or other gripping elements may incorporated into the wedges to increase the friction between metal cable 625 and the wedges. Locking disc 620 may move from an active position (unlocked phase) in which clamping wedges are released from metal cable 625 allowing linear movement of metal cable 625 to an inactive position (locked phase) in which clamping wedges are clamped onto metal cable 625 to inhibit linear movement of metal cable 625. Metal cable 625 may be made of any metallic material, however this is non-limiting and metal cable 625 may be made of any flexible cut-resistant material such as a manufactured fiber or rope. Metal cable 625 may be connected to container 630.

Container 630 may be a bag or bag like apparatus having a fabric outside shell, a metal wire frame mesh middle layer, and an interior lining. Container 630 may have a series of panels extending upward from a base including a front panel and rear panel. Panels may be connected by a series of panel seems at the corner edges. The front panel and rear panel each have an upper edge portion. A flap 632 may extend outwardly and upwardly from the upper edge portion of the rear panel. Flap 632 may be pulled and extended such that flap 632 rests on the outside of the front panel as illustrated in FIG. 15. In some embodiments, flap 632 may be secured against the outside of front panel by one or more fasteners such as but not limited to hook and loop fasteners, buckles, or latches.

Panels may be attached to handle 642 whereby handle allows an operator such as parcel recipient 105 or parcel deliverer 110 to transport container 630. Handle 622 may also pass through an aperture of a hook 644, hook 644 allowing container 630 to be attached to a door frame or in some embodiments a door handle. Hook 624 may be folded over on to itself to form a bend whereby the bend of hook 624 is configured to fit over the top surface of a door frame thus restraining movement of container 630 with respect to the door frame.

As illustrated in FIG. 14 pocket 631 may be affixed to the inner side of the back panel. Pocket 631 may have a panel with two longitudinally extending edges and a lateral edge securely affixed to the inner surface of the back panel such that pocket 631 provides an upwardly directed opening whereby locking disc 620 may be positioned inside the pocket 631. Pocket 631 may have one or more apertures 623 through the panel to allow metal cable 625 to extend out from locking disc 620 to pass through the aperture providing more space for metal cable 625.

One or more eyelets 636 may be positioned near the upper edges of the panels of container 630. Eyelets 636 may be used in conjunction with metal cable 625 to gather the upper edge of container 630 together to close the opening of container 630. Metal cable 625 may be threaded through eyelets 636 so that by drawing the ends or a section of metal cable 625 from the interior of container 630 to the exterior of container 630, the opening in container 630 is decreased in size to close the opening.

In operation, when parcel deliverer 110 delivers a parcel 101, an unlocking sequence may be initiated when a detected, scanned, or entered code entered by parcel deliverer 110 matches the stored code on tracking number and code database 440 on server 400. Locking disc 620 may then be activated and unlocked by an incoming transmission sent by server 400 and received by the communication system. When locking disc 620 is unlocked, the microcontroller may then send a signal to the cable feeding mechanism, commanding the cable feeding mechanism to rotate the rollers extending metal cable 625 for a predetermined amount of time. This separates the individual eyelets of container 630 and extends metal cable 625 between eyelets 636, increasing the size of the opening in container 630. The user then may access the interior of container 630 to remove parcel 101.

Parcel 101 may then be placed inside of unlocked container 130 by parcel deliverer 110. After parcel 101 has been placed in container 130, parcel deliverer 110 may scan another code. When parcel deliverer 110 has completed placing parcels 101 inside container 630, the sensor system including one or more accelerometers may detect that there has been no movement status change directionally or vibrationally such that parcel securing device 115 has not moved for a certain amount of time, such as five seconds, whereby a signal is then sent to the microcontroller of the control system. The microprocessor sends a signal to the cable feeding mechanism to retract metal cable 625 back through locking disc 620 causing metal cable 625 to be pulled away from eyelets 636 of container 630. This decreases the space between eyelets 636 and decreases the size of the opening of container 630.

Parcel recipient 105 may then unlock container 630 and retrieve parcel 101. Parcel recipient 105 may insert a manual code or unlock parcel securing system API 386 and retrieve parcel 101. Location tracking module 410 may determine that parcel recipient computing device 305 is in proximity to parcel securing device 115 and send a signal to the microcontroller which may then send a signal to the cable feeding mechanism, commanding the cable feeding mechanism to rotate the rollers extending metal cable 625 for a predetermined amount of time, unlocking container 630 and allowing parcel recipient 105 to retrieve parcel 101.

After parcel 101 has been retrieved from container 630 the sensor system including one or more accelerometers detect that there has been no status change directionally or vibrationally such that parcel securing device 115 has not moved for a certain amount of time and sends a signal to the microcontroller of the control system. The microprocessor sends a signal to cable feeding mechanism to retract metal cable 625 back through locking disc 620 causing metal cable 625 to be pulled away from eyelets 636 of container 630.

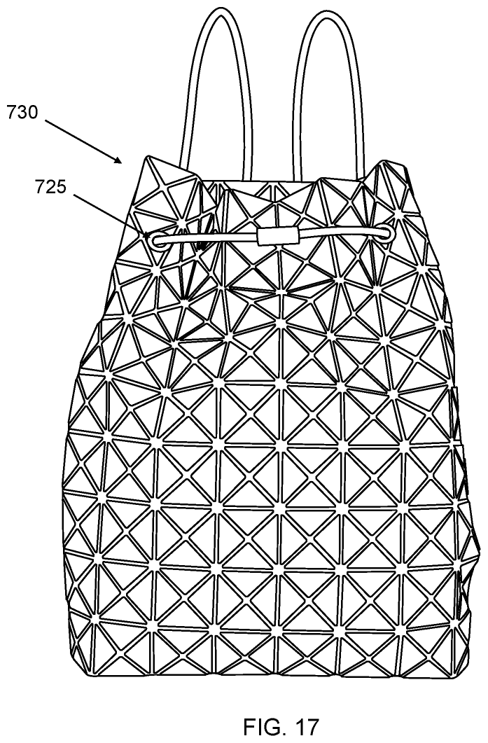

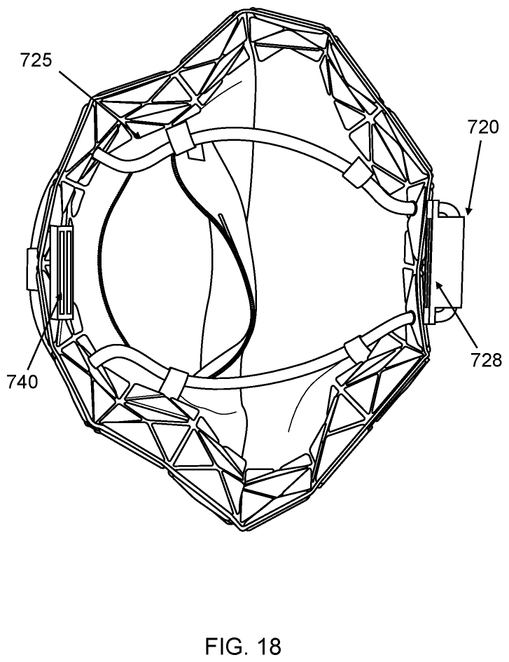

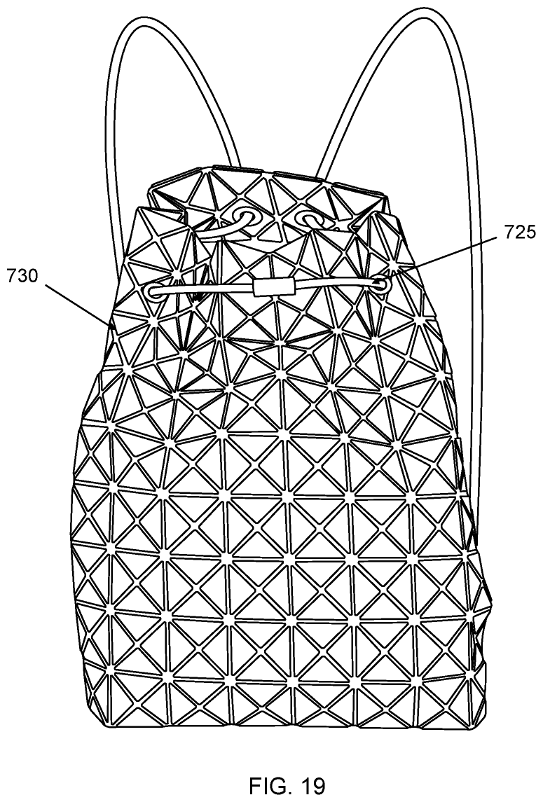

In one or more non-limiting other embodiments, parcel securing device, as illustrated in FIG. 17-19, may utilize an electromagnetic locking mechanism in combination with a motor that extends and retracts metal cable 725 connected to container 730 to secure container 730. When locking bar 720 receives a signal from server 400 to lock or unlock container 730, the electromagnetic lock will engage and disengage. In these embodiments, locking bar 720 may include exteriorly facing electromagnetic plate 728 which mates with a closely positioned armature plate 740 mounted to container 730 so that upon electrical energization of electromagnetic plate 728, armature plate 740 becomes electromagnetically bonded to the electromagnetic plate 728 and hence the housing of locking bar 720.

Electromagnetic plate 728 and armature plate 740 have a generally complementary contact surfaces of a relatively large surface contact area such that the force created by the magnetic flux is strong enough to keep container 730 locked even under stress. Armature plate 740 may be mounted to the upper area of container 730 so that armature plate 740 and the electromagnetic plate 728 align and are in mutual surface-to-surface contact when container 730 is closed. In one or more non-limiting embodiments, holes may be drilled or otherwise positioned through container 730 to line up with the mounting holes on locking bar 720 such that locking bar 720 is on the outside of container 730.

Fasteners, such as but not limited to nuts and bolts, may be used to secure locking bar 720 to container 730. Armature plate 740 may be positioned in a similar manner on the inside of container 730 on the opposite side of electromagnetic plate 728 so that they come into close proximity when container 730 is being pulled close. When electromagnetic plate 728 is energized, a current passing through electromagnetic plate 728 creates a magnetic flux that causes armature plate 740 to attract to electromagnetic plate 728, creating a locking action.

Armature plate 740 may have one or more apertures so that it may be mounted to container 730 and fixated opposite to electromagnetic plate 728 such that when the electromagnetic plate engages, armature plate 740 will be attracted to the electromagnetic plate and prevent the container 730 from opening by force. If locking bar 720 receives a communication from server 400 to initiate the unlocking process, negative direct current may be supplied to the electromagnetic plate thus disengaging the armature plate form the electromagnetic plate allowing for unlocking container 730. Once parcel 101 has been placed inside of container 730, the electromagnetic lock may once again engage whereby current is supplied to the electromagnetic plate 728 so that armature plate 740 will be attracted to electromagnetic plate 728 and prevent container 730 from opening by force.

In further embodiments, parcel securing device may utilize an electromagnetic locking mechanism, without a motor. Electromagnetic locking mechanism is connected to container 730 such that user may manually place armature plate 740 in close proximity to electromagnetic plate 725. When locking bar 720 receives a signal from server 400 to lock or unlock container 730, the electromagnetic lock will engage and disengage.

The foregoing description of the invention has been presented for purposes of illustration and description and is not intended to be exhaustive or to limit the invention to the precise form disclosed. Many modifications and variations are possible in light of the above teaching. The embodiments were chosen and described to best explain the principles of the invention and its practical application to thereby enable others skilled in the art to best use the invention in various embodiments and with various modifications suited to the use contemplated. The scope of the invention is to be defined by the below claims.

What is claimed is:

1. A parcel securing system comprising:
one or more databases coupled via a network;
one or more processors coupled to the one or more databases; and
at least one computing device coupled to the one or more processors and the one or more databases via the network; wherein the one or more processors are configured to:
collecting and storing user data related to a first user in the one or more databases, wherein the user data comprises tracking codes of one or more parcels expected by a first user;
receiving, via the network, a second user request to open a parcel securing device, the parcel securing device comprising one or more sensors, a microcontroller configured to control a motor, the motor in a housing, the motor configured to extend and retract a cable or rope, the cable or rope when extended opening a container, the cable or rope when retracted closing the container, the request having an inputted code;
verifying, in response to the request from the second user, that the inputted code matches the tracking codes of the one or more parcels expected by the first user, wherein if the inputted code is verified to match the tracking codes of the one or more parcels expected by the first user, allow request; and
unlocking, in response to the allowed request, the parcel securing device, wherein the motor extends the cable or rope, opening the container.

2. The parcel securing system of claim 1 wherein the one or more processors are further configured to:
locking, wherein the motor of the parcel securing device retracts the cable or rope, closing the container.

3. The parcel securing system of claim 2, wherein the one or more processors are further configured to:
verifying that a computing device of the first user is within a predetermined distance of the parcel securing device; and
unlocking, in response to the verification that the computing device of the first user is within a predetermined distance of the parcel securing device, wherein the motor extends the cable or rope, opening the container.

4. The parcel securing system of claim 3 wherein the one or more processors are further configured to:
detecting, by one or more sensors, while parcel securing device is unlocked, any movement of the parcel securing device; and
locking, in response to the parcel securing device having no detected movement by the one or more sensors for a predetermined amount of time, wherein the motor retracts the cable or rope, closing the container.

5. The parcel securing system of claim 3 wherein the one or more processors are further configured to:
presenting the location of the parcel securing device, determined by a GPS receiver or wireless network position on the parcel securing device, via a user interface on the computing device to the first user.

6. The parcel securing system of claim 1 wherein the one or more processors are further configured to: generating light effects by affecting the emission of light through one or more LED on the parcel securing device.

7. The parcel securing system of claim 5 wherein the one or more processors are further configured to: generating an alarm, in response to the parcel securing device having been tampered with or moved from a predetermined area as determined by a GPS receiver or wireless network position.

8. The parcel securing system of claim 1 wherein the one or more processors are further configured to: scanning, by a scanner of the parcel securing device, tracking codes of the one or more parcels.

9. The parcel securing system of claim 1, the cable or rope connected to a rotatable spool within a drum in contact with the motor wherein an outer portion of the cable or rope is configured to be withdrawn from the rotatable spool while permitting an inner end of the cable or rope to be secured, wherein an outer end of the cable or rope is protruding out of a hole on a side of the housing.

10. The parcel securing system of claim 9 further comprising: a screw cap at the outer end of the cable or rope configured to prevent the outer end of the cable or rope from moving back into the housing.

11. A parcel securing system comprising:
a parcel securing device, the parcel securing device comprising one or more sensors, a microcontroller configured to control a motor, the motor in a housing, the motor configured to extend and retract a cable or rope, the cable or rope when extended allowing access to a container, the cable or rope when retracted preventing access to the container.

12. The parcel securing system of claim 11, wherein the cable or rope is enclosed within a hem of the container.

13. The parcel securing system of claim 11, the cable or rope connected to a rotatable spool within a drum in contact with the motor wherein an outer portion of the cable or rope is configured to be withdrawn from the spool while permitting an inner end of the cable or rope to be secured, wherein an outer end of the cable or rope is protruding out of a hole on a side of the housing.

14. The parcel securing system of claim 13 further comprising: a screw cap at the outer end of the cable or rope configured to prevent the outer end of the cable or rope from moving back into the housing.

15. A parcel securing system comprising:
a parcel securing device, the parcel securing device comprising one or more sensors, a microcontroller configured to control a feeding mechanism, the feeding mechanism in a housing, the feeding mechanism having a motor, the motor configured to extend and retract a cable or rope through one or more apertures on a front and rear end of the parcel securing device, wherein a length of the cable or rope is weaved within one or more eyelets of a container, the cable or rope when extended allowing access to the container, the cable or rope when retracted preventing access to the container.

16. The parcel securing system of claim 15, further comprising a pocket, the pocket configured for storing the parcel securing device within the bag.

17. The parcel securing system of claim 16, the bag further comprising a handle.

18. The parcel securing system of claim 17, the bag further comprising a hook, the hook having an aperture wherein the handle is positioned through the hook, the hook having a bend configured to secure the bag to a door frame.

19. The parcel securing system of claim 18 further comprising:
one or more databases coupled via a network;
one or more processors coupled to the one or more databases; and
at least one computing device coupled to the one or more processors and the one or more databases via the network; wherein the one or more processors are configured to:
collecting and storing user data related to a first user in the one or more databases, wherein the user data comprises tracking codes of one or more parcels expected by the first user;
receiving, via the network, a second user request to open the parcel securing device, the parcel securing device further comprising one or more sensors, the request having an inputted code;
verifying, in response to the request from the second user, that the inputted code matches the tracking codes of the one or more parcels expected by the first user, wherein if the inputted code is verified to match the tracking codes of the one or more parcels expected by the first user, allow request; and
unlocking, in response to the allowed request, the parcel securing device, wherein the motor extends the cable or rope, opening the container.

20. The parcel securing system of claim 19 wherein the one or more processors are further configured to:
locking, the parcel securing device wherein the motor retracts the cable or rope, closing the container;
verifying that a computing device of the first user is within a predetermined distance of parcel securing device; and
unlocking, in response to the verification that the computing device of the first user is within a predetermined distance of the parcel securing device, wherein the motor extends the cable or rope, opening the container.
